(19) United States
(12) Patent Application Publication
(10) Pub. No.: US 2025/0275021 A1
(43) Pub. Date: Aug. 28, 2025

(54) INDUCTION ENERGY TRANSMISSION SYSTEM

(71) Applicant: BSH Hausgeräte GmbH, Munich (DE)

(72) Inventors: Jesus Manuel Moya Nogues, Zaragoza (ES); Sergio Llorente Gil, Zaragoza (ES); Javier Serrano Trullen, Zaragoza (ES); Jorge Tesa Betes, Zaragoza (ES); Jorge Pascual Aza, Zaragoza (ES); Francisco Villuendas Lopez, Zaragoza (ES); Emilio Plumed Velilla, Zaragoza (ES)

(21) Appl. No.: 18/857,853

(22) PCT Filed: Apr. 18, 2023
(86) PCT No.: PCT/EP2023/059969

§ 371 Date: Oct. 18, 2024

(30) Foreign Application Priority Data
Apr. 21, 2022 (EP) 22382371.7

(51) Int. Cl. H05B 6/06; H02J 50/10; H02J 50/80; H05B 6/12

(52) U.S. Cl. CPC H05B 6/062; H02J 50/10; H02J 50/80; H05B 6/1236; H05B 2213/06

(57) ABSTRACT

An induction energy transmission system includes a supply unit including a supply induction element designed to inductively provide energy, a placement unit including a receiving induction element designed to receive the inductively provided energy, said placement unit including an operating parameter set, and a control unit designed to control the supply unit and in the event of a signaled modification of an operating parameter of the operating parameter set of the placement unit to introduce a safety period and to adapt the inductively provided energy to the modified operating parameter within the safety period.

The invention relates to an induction energy transmission system as claimed in the preamble of claim 1 and a method for operating an induction energy transmission system as claimed in claim 12.

Induction energy transmission systems for the inductive transmission of energy from a primary coil of a supply unit to a secondary coil of a placement unit are already known from the prior art. For example, in the document U.S. Pat. No. 3,761,668 A an induction cooktop is proposed that in addition to an inductive heating of cookware is also provided so as to supply energy to small household appliances, for example a mixer. An energy that is provided inductively by a primary coil of the induction cooktop in this case is in part transmitted to a secondary coil that is integrated into the small household appliance. Some placement units can be operated in various operating modes, for example in a heating mode and a keep warm mode. The disadvantage in the case of hitherto known induction energy transmission systems is that in the case of a load change of the placement unit, for example a change from a first operating mode into a second operating mode, during an inductive provision of energy by the primary coil, on account of voltage peaks that occur, there is an increased risk of damage to electrical components, for example inverters, whereby an operational safety is limited.

The object of the invention is in particular, however not limited to, providing an apparatus of the generic type having improved characteristics with regard to an operational safety. The object is achieved in accordance with the invention by the features of claims 1 and 12, while advantageous embodiments and developments of the invention are apparent in the subordinate claims.

The invention is based on an induction energy transmission system, in particular induction cooking system, having a supply unit, which has at least one supply induction element for the inductive provision of energy, having a control unit for controlling the supply unit, and having at least one placement unit that has at least one receiving induction element for receiving the inductively provided energy.

It is proposed that in the event of a signaled modification of at least one operating parameter of an operating parameter set of the placement unit the control unit is provided so as to introduce a safety period and so as to adapt the energy, which is provided inductively by the supply unit, to the modified operating parameter within the safety period.

Due to one such embodiment, it is advantageously possible to provide an induction energy transmission system having improved operational safety. It is possible for the risk of damage to electronic components of the induction energy transmission system, in particular to an inverter unit of the supply unit, to be reduced, preferably minimized, in the event of a load change of the placement unit. Furthermore, it is also advantageously possible to enable an improved protection of electrical components of the placement unit during a load change. It is consequently advantageously possible to provide a particularly reliable and durable induction energy transmission system. Furthermore, it is possible to advantageously improve a user experience.

The induction energy transmission system has at least one main functionality in the form of a wireless energy transmission, in particular in a wireless energy supply of placement units. In one advantageous embodiment, the induction energy transmission system is designed as an induction cooking system having at least one further main function that deviates from a pure cooking function, in particular at least one energy supply and an operation of small household appliances. For example, the induction energy transmission system could be designed as an induction oven system and/or as an induction grill system. In particular, the supply unit could be designed as part of an induction oven and/or as part of an induction grill. It is preferred that the induction energy transmission that is designed as an induction cooking system is designed as an induction cooktop system. The supply unit is then preferably designed as part of a cooktop, in particular an induction cooktop. In a further advantageous embodiment, the induction energy transmission system is designed as a kitchen energy supply system and can be provided in addition to a main function in the form of an energy supply and an operation of small household appliances in addition to the provision of cooking functions.

A “supply unit” is to be understood to mean a unit that in at least one operating state provides energy inductively and that in particular has a main functionality in the form of an energy provision. With regard to the provision of energy, the supply unit has at least one supply induction element that has in particular at least one coil, in particular at least one primary coil, and/or is designed as a coil and that in particular in the operating state provides energy inductively. The supply unit could have at least two, in particular at least three, advantageously at least four, particularly advantageously at least five, preferably at least eight and particularly preferably multiple supply induction elements that in the operating state in each case could provide energy inductively, namely in particular to a single receiving induction element or to at least two or multiple receiving induction elements at least of a placement unit and/or at least of a further placement unit. At least some of the supply induction elements could be arranged in the vicinity of one another, for example in a row and/or in the form of a matrix. It is preferred that the supply unit has at least one inverter unit. It is preferred that the inverter unit in the operating state performs a frequency conversion and converts in particular an input side low frequency AC voltage into an output side high frequency AC voltage. It is preferred that the low frequency AC voltage has a frequency of at most 100 Hz. It is preferred that the high frequency AC voltage has a frequency of at least 1000 Hz. The inverter unit is connected to the control unit and can be controlled by the control unit by means of control signals. It is preferred that the inverter unit is provided so as to set the energy, which is provided inductively by the at least one supply induction element, by setting the high frequency AC voltage. It is preferred that the inverter unit has at least one inverter switching element. It is preferred that the inverter switching element generates an oscillating electrical current, preferably having a frequency of at least 15 kHz, in particular of at least 17 kHz, and advantageously of at least 20 kHz, for an operation of the at least one supply induction element. It is preferred that the inverter unit comprises at least two inverter switching elements that preferably are designed as bipolar transistors having isolated gate electrodes and particularly advantageously at least one damping capacitor. It is preferred that the supply unit comprises at least one rectifier unit that is provided so as to rectify a mains AC voltage that is provided by a mains AC voltage source to which the induction energy transmission system is connected in an operating state.

A “placement unit” is to be understood to mean a unit that in at least one operating state inductively receives energy and converts the inductively received energy at least in part into at least a further energy form so as to provide at least one main function. For example, the energy that is inductively received by the placement unit in the operating state could be converted, in particular directly, into at least one further energy form such as heat. Alternatively or in addition, the placement unit could have at least one electrical consumer, for example an electric motor or the like. The placement unit has at least one receiving induction element for receiving the energy that is provided inductively. The placement unit could have for example at least two, in particular at least three, advantageously at least four, particularly advantageously at least five, preferably at least eight and particularly preferably multiple receiving induction elements that could in each case inductively receive energy in particular in the operating state, in particular from the supply induction element. The placement unit could be designed for example as an item of cookware. The item of cookware preferably has at least one food receiving compartment and converts the inductively received energy in the operating state at least in part into heat so as to heat the food that is arranged in the food receiving compartment. The placement unit that is designed as an item of cookware preferably has at least one further unit for providing at least a further function, which goes beyond a pure heating of food and/or deviates from a heating of food. For example, the further unit could be designed as a temperature sensor or as a stirring unit or the like. Alternatively, the placement unit could be designed as a small household appliance. It is preferred that the small household appliance is a household appliance that is fixed to a particular location, which has at least the receiving induction element and at least one function unit that provides at least one household appliance function in an operating state. “Fixed to a particular location” is to be understood in this context to mean that the small household appliance can be freely positioned in a household by a user and in particular without aid, in particular in contrast to a large household appliance that is fixedly positioned and/or installed at a specific position in a household, such as an oven or a refrigerator. It is preferred that the small household appliance is designed as a small kitchen appliance and provides at least one main function in the operating state so as to process food. The small household appliance could be designed, without being limited thereto, for example as a food processor and/or as a mixer and/or as a stirrer and/or as a grinder and/or as a set of kitchen scales or as a kettle or as a coffee machine or as a rice cooker or as a milk frother or as a fryer, in particular an air fryer, or as a toaster or as a juicer or as a cutting machine or the like.

The receiving induction element of the placement unit comprises at least one secondary coil and/or is designed as a secondary coil. In an operating state of the placement unit, the receiving induction element supplies at least one consumer of the placement unit with electrical energy. Furthermore, it is conceivable that the placement unit has an energy storage device, in particular an accumulator, which is provided so as to store electrical energy that is received via the receiving induction element in a charging state and to provide the energy in a discharging state so as to supply the function unit.

It is preferred that the induction energy transmission system has at least one placement plate for placing the placement unit. A “placement plate” is to be understood to mean at least one, in particular plate-like, unit that is provided for a placement of at least one placement unit and/or for putting down at least one item of food to be cooked. The placement plate could be designed for example as a worktop, in particular as a kitchen worktop, in particular of the induction energy transmission system. Alternatively or in addition, the placement plate could be designed as a cooktop plate. The placement plate that is designed as a cooktop plate could form in particular at least a part of a cooktop outer housing and, in particular together with at least one outer housing unit, to which the placement unit that is designed as a cooktop plate in at least one mounted state in particular could be connected, could form the cooktop outer housing to a large extent. It is preferred that the placement plate is produced from a non-metal material. The placement plate could be formed for example at least to a large extent from glass and/or from glass ceramic and/or from neolith and/or from Dekton and/or from wood and/or from marble and/or from stone, in particular from natural stone, and/or from laminate and/or from plastic and/or from ceramic.

In the current application, designations of position such as “below” or “above” relate to a mounted state of the placement plate provided that this is not explicitly described otherwise. In the mounted state, the supply unit is preferably arranged below the placement plate.

A “control unit” is to be understood to mean an electronic unit that is provided so as to control and/or regulate at least the supply unit. The control unit preferably comprises a computing unit and in particular in addition to the computing unit a storage unit having a control and/or regulating program that is stored therein, which is provided so as to be executed by the computing unit.

An “operating parameter set” is to be understood to mean a plurality of at least two operating parameters of the placement unit with the aid of which the control unit controls the energy, which is provided inductively by the supply unit, according to a prevailing operating mode of the placement unit. At least one operating parameter of the operating parameter set can be a dynamic operating parameter, in other words in particular an operating parameter that changes over time. The dynamic operating parameter can be for example a power level and/or type of electrical loads to be operated simultaneously and/or a total electrical load and/or an impedance of the placement unit in a specific operating mode. The operating parameter set can comprise in addition to the at least one dynamic operating parameter further operating parameters, in particular static operating parameters, for example a constructive and/or geometric parameter of the placement unit, in particular of the receiving induction element. Constructive and/or geometric parameters in this case, without being limited thereto, could include for example a form and/or size, in particular a radius and/or diameter, and/or a cross-sectional surface and/or a number of windings and/or a material and/or a spatial position of the receiving induction element within the placement unit. Further operating parameters of the operating parameter set can comprise for example electrical parameters of the receiving induction element, for example an amount of an electrical resistance and/or an impedance and/or an inductance and/or a magnetic flux density and/or a resonance frequency and/or a material constant, for example a magnetic permeability. It is preferred that at least one operating parameter of the operating parameter set comprises at least one operating parameter of the placement unit, for example a maximum power and/or a minimum power and/or number of power levels and/or a number and/or type of operable electrical loads and/or a voltage and/or current strength that is required in a specific operating mode.

The control unit is provided so as to operate the supply unit, in particular at least an inverter switching element of the inverter unit, during the safety period in a safety mode, wherein in the safety mode parameters of the supply unit, for example a switching frequency and/or a duty cycle of the inverter switching element of the inverter unit and/or a voltage and/or current strength that is prevailing at the inverter switching element, are changed with respect to a normal operating mode in order to enable a safe changing of the at least one operating parameter of the operating parameter set of the placement unit. The control unit can be provided for example so as to operate the inverter unit in the normal operating mode at a switching frequency between 15 kHz and 50 kHz and a duty cycle of 1.0 and in the safety mode at a switching frequency of 75 kHz and a duty cycle of 0.5.

In the current document, numerals such as “first” and “second”, which precede certain terms, are only used to differentiate objects and/or to allocate objects to one another and do not imply an existing total number and/or ranking of the objects. In particular, a “second object” does not necessarily imply a presence of a “first object”.

In this document, “at least essentially” is to be understood to mean that a deviation from a predetermined value is less than 25%, preferably less than 10% and particularly preferably less than 5% of the predetermined value.

“Provided” is to be understood to mean specifically programmed, designed and/or equipped. The fact that an object is provided for a specific function is to be understood to mean that the object fulfills and/or performs this specific function in at least one application state and/or operating state.

Furthermore, it is proposed that the placement unit is provided so as to already signal at least one period duration of a mains AC voltage prior to a planned modification of the at least one operating parameter of the operating parameter set. Consequently, it is advantageously possible to further increase an operational safety. In particular, it is possible to ensure a prompt introduction of the safety period prior to a modification of the at least one operating parameter of the placement unit. The mains AC voltage refers in this case to an electrical AC voltage that is provided by a voltage source, for example a plug socket or a three-phase connection, so as to operate the induction energy transmission system. The period duration of the mains AC voltage corresponds to the reciprocal of the mains frequency. In Europe, a mains AC voltage is typically provided at a mains frequency of 50 Hz so that a period duration of the mains AC voltage in this case is 20 milliseconds.

Moreover, it is proposed that the control unit is provided so as to transmit a time period of the safety period to the placement unit. Due to an embodiment of this type, it is advantageously possible to further improve an operational safety. It is advantageously possible to enable a safe modification of the at least one operating parameter of the operating parameter set of the placement unit. In particular, it is possible to achieve an improved protection of electronic components of the placement unit.

Furthermore, it is proposed that the control unit is provided so as to operate the supply unit in the safety period using reduced energy with respect to a normal operating period. Due to an embodiment of this type, it is advantageously possible to further increase an operational safety. “Normal operating period” is to be understood to mean an operating period in which the control unit operates the supply unit, in particular the inverter unit of the supply unit, in the normal operating mode. The control unit can be provided so as to operate the supply unit in the safety period using an energy that is reduced with respect to the normal operating period by at least 40%, in particular by at least 50%, advantageously by at least 60%, particularly advantageously by at least 70%, preferably by at least 80% and particularly preferably by at least 90%. In a particularly advantageous embodiment, it is proposed that the control unit is provided so as to interrupt the energy supply of the supply unit during the safety period. As a consequence, it is advantageously possible to further improve an operational safety.

Furthermore, it is proposed that a duration of the safety period corresponds to at least twice the duration of an operating parameter change of the placement unit. As a consequence, it is advantageously possible to increase a flexibility. Since a duration of an operating parameter change can be greatly varied in various placement units, for example due to different switching strategies, it is possible to enable a more flexible and safe use of various placement units if the duration of the safety period corresponds to at least twice the duration of the operating parameter change of the placement unit. It is preferred that the duration of the safety period corresponds to at least 5 milliseconds. In one advantageous embodiment, it is proposed that a duration of the safety period corresponds to at least half of a period duration of a mains AC voltage. The duration of the safety period can correspond to an integer multiple of the half period duration of the mains AC voltage, for example to twice, three times or to four times half of the period duration of the mains AC voltage. It is preferred that the duration of the safety period is at most 100 milliseconds.

Furthermore, it is proposed that the induction energy transmission system has a communication unit for wireless data transmission, in particular by NFC, between the placement unit and the control unit. The communication unit has at least one communication element for the wireless data transmission. It would also be conceivable that the communication unit has at least one inductive communication element that is designed as separate to the supply induction element and is connected to the control unit. A wireless communication could then be provided by means of inductive communication signals between the inductive communication element and the receiving induction element or a further inductive communication element of the communication unit, which is arranged in the placement unit. The communication unit could be provided alternatively or in addition to a wireless data transmission between the control unit and the placement unit by RFID or by WIFI or by Bluetooth or by ZigBee or for wireless data transmission according to another suitable wireless communication standard. It is preferred that the communication unit is provided for a wireless data transmission between the placement unit and the control unit by NFC and has at least one communication element that is provided for a wireless data transmission by NFC. The communication unit is preferably provided for a bidirectional wireless data transmission, in other words both for wireless receiving as well as wireless transmission of data. It is preferred that the communication unit has at least one communication element that is connected to the control unit and in particular is provided for wireless receiving and transmission of data. It is preferred that the communication unit has at least one further communication element that is arranged within the placement unit and is provided in particular for wireless receiving and transmission of data.

Furthermore, it is proposed that the placement unit is designed as a small household appliance. As a consequence, it is advantageously possible to provide an induction energy transmission system with a particularly high degree of user comfort.

The invention further relates to a small household appliance of an induction energy transmission system according to one of the above-described embodiments. A small household appliance of this type is distinguished in particular by a high degree of operational safety, and also a high degree of reliability and durability during an operation within the induction energy transmission system.

The invention moreover relates to a cooktop of an induction energy transmission system according to one of the above-described embodiments, wherein the cooktop has the supply unit. A cooktop of this type is distinguished in particular by a high degree of operational safety, and also a high degree of reliability and durability during operation within the induction energy transmission system. In addition to the supply unit, the cooktop can comprise further units and/or elements of the induction energy transmission system, for example the control unit and/or the placement plate.

The invention is further based on a method for operating an induction energy transmission system according to one of the above-described embodiments, having a supply unit, which has at least one supply induction element for the inductive provision of energy, and having at least one placement unit, which has at least one receiving induction element for receiving the inductively provided energy.

It is proposed that in the event of a signaled modification of at least one operating parameter of an operating parameter set of the placement unit, a safety period is introduced within which energy that is provided inductively by the supply unit is adapted to the modified operating parameter. By means of such a method, it is advantageously possible to enable particularly safe operation of the induction energy transmission system.

The induction energy transmission system in this case is not to be limited to the above-described application and embodiment. In particular, the induction energy transmission system can have a number of individual elements, components and units that deviates from a number mentioned herein for fulfilling a function described herein.

Further advantages are provided in the following description of the drawing. An exemplary embodiment of the invention is illustrated in the drawing. The drawing, the description and the claims include numerous features in combination. The person skilled in the art will also take the features into account expediently and will combine the features into expedient further combinations.

In the drawing:

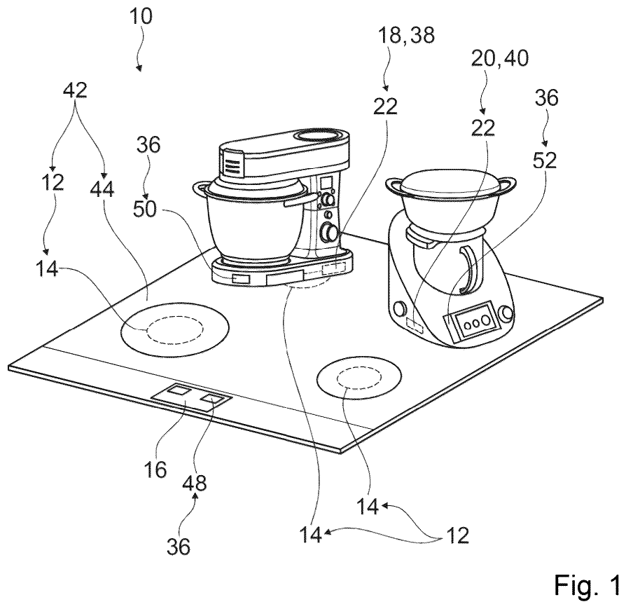

FIG. 1 shows an induction transmission system having a supply unit, a control unit and two placement units in a schematic illustration,

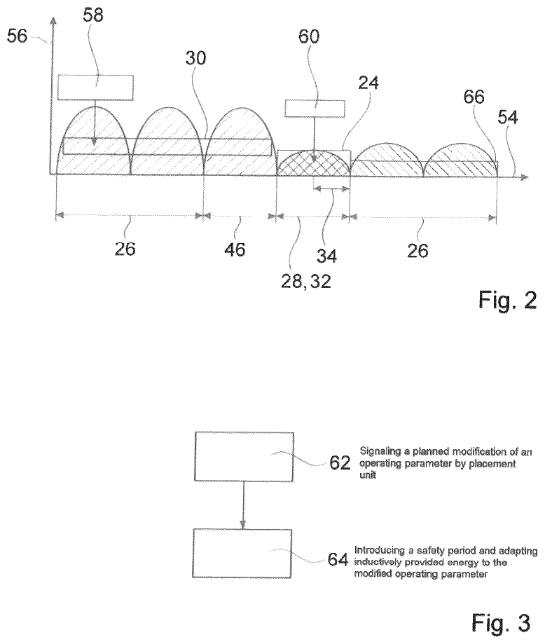

FIG. 2 shows a schematic diagram for illustrating a function of the induction energy transmission system and

FIG. 3 shows a schematic method flow diagram for illustrating a method for operating the induction energy transmission system.

FIG. 1 shows an induction energy transmission system 10 in a schematic illustration. The induction energy transmission system 10 has a supply unit 12. The supply unit 12 comprises at least one supply induction element 14 for the inductive provision of energy. In the present case, the supply unit 12 comprises four supply induction elements 14.

The induction energy transmission system 10 has a placement plate 44. The supply unit 12 is arranged below the placement plate 44.

The induction energy transmission system 10 has a control unit 16 for controlling the supply unit 12. The supply unit 12 comprises an inverter unit having at least one inverter (not illustrated), wherein the inverter unit can be controlled by the control unit 16. The induction energy transmission system 10 is provided for a connection to a mains AC voltage source (not illustrated), for example a plug socket or a three-phase connection. In an operating state, the induction energy transmission system 10 is supplied via the mains AC voltage source with a mains AC voltage. The supply unit 12 has a rectifier unit (not illustrated) that is provided so as to rectify the mains AC voltage and so as to supply the inverters of the inverter unit on the input side with a rectified mains AC voltage.

The induction energy transmission system 10 in the present case is designed as an induction cooking system and comprises a cooktop 42. The cooktop 42 is designed as an induction cooktop. In the present case, the placement plate 44 is designed as a cooktop plate of the cooktop 42. In the present case, the cooktop 42 has the supply unit 12. In the present case, the control unit 16 is likewise part of the cooktop 42.

The induction transmission system 10 has at least one placement unit 18. The placement unit 18 has a receiving induction element 22 for receiving the energy that is provided inductively by the supply unit 12. In the present case, the placement unit 18 is designed as a small household appliance 38, namely as a food processor.

The induction energy transmission system 10 in the present case has a further placement unit 20. The further placement unit 20 likewise comprises a receiving induction element 22 for receiving the energy that is provided inductively by the supply unit 12. The further placement unit 20 in the present case is designed as a further small household appliance 40, namely as a fryer, in particular an air fryer.

The induction energy transmission system 10 has a communication unit 36. The communication unit 36 is provided for a wireless data transmission between the placement unit 18 and the control unit 16. In the present case, the communication unit 36 is moreover also provided for a wireless data transmission between the further placement unit 20 and the control unit 16. The communication unit 36 has a communication element 48 that is connected to the control unit 16 and is provided for wireless transmission and receiving of data.

The communication unit 36 has a further communication element 50 that is arranged in the placement unit 18 and is provided for wireless transmission and receiving of data. The communication unit 46 moreover has a further communication element 52 that is arranged in the further placement unit 20 and is provided for wireless transmission and receiving of data. In the present case, the communication unit 46 is designed as an NFC communication unit and is provided for wireless data transmission by NFC between the control unit 16 and the placement unit 18 and/or the further placement unit 20.

FIG. 2 shows a schematic diagram for illustrating a function of the control unit 16. A time in milliseconds is plotted on an abscissa 54 of the diagram. An electrical power in watts, which is provided inductively by a supply induction element 14 of the supply unit 12, is plotted on an ordinate 56 of the diagram.

The control unit 16 in the event of a signaled modification of at least one operating parameter of an operating parameter set of the placement unit 18 is provided so as to introduce a safety period 24 and to adapt the energy, which is provided inductively by the supply unit 12, to the modified operating parameter within the safety period 24. The operating parameter of the placement unit 18 can be, without being limited thereto, for example a total electrical load and/or an impedance and/or a required electrical power of the placement unit 18 in a specific operating mode. For example, the placement unit 18 that is designed as a food processor can be provided in a first operating mode so as to heat and stir food and in a second operating mode so as to keep food warm, so that a total electrical load and/or an impedance and/or a required electrical power of the placement unit 18 in the first operating mode is/are greater than in the second operating mode.

During a normal operating period 30, the supply induction element 14 provides an energy inductively to the receiving induction element 22, wherein an electrical power that is provided during the normal operating period 30 corresponds to a power requirement of the placement unit 18 in the first operating mode. In the diagram of FIG. 2, the normal operating period 30 is illustrated as an example for a time period that corresponds to three half period durations 46 of the mains AC voltage. A period duration 26 of the mains AC voltage corresponds to a reciprocal of a mains frequency of the mains AC voltage. The mains AC voltage can have for example a mains frequency of 50 hertz so that the period duration 46 of the mains AC voltage corresponds to 20 milliseconds. The illustrated time period of the normal operating period 30 thus corresponds to 30 milliseconds, wherein the normal operating period 30 can of course also be shorter or significantly longer.

The placement unit 18 is provided so as to so as to already signal at least one period duration 26 of the mains AC voltage prior to a planned modification of the at least one operating parameter of the operating parameter set, for example a modification of the total electrical load in the event of a change from the first operating mode into the second operating mode. The placement unit 18 could signal the planned modification of the at least one operating parameter of the operating parameter set of the control unit 16 for example at a first point in time 58 within the normal operating period 30, namely by means of the communication unit 36. The modification of the at least one operating parameter of the operating parameter set is then performed at a later second point in time 60, which is temporally spaced from the first point in time 58 by at least a period duration 26 of the mains AC voltage, in other words at least 20 milliseconds.

The control unit 16 is further provided so as to transmit a time period 28 of the safety period 24 to the placement unit 18, namely by means of the communication unit 36. After signaling the planned modification of the at least one operating parameter of the operating parameter set by the placement unit 18 at the first point in time 58, the control unit 16 transmits the time period 28 of the safety period 24 to the placement unit 18, namely by means of the communication unit 36. The modification of the at least one operating parameter of the operating parameter set is then performed at the second point in time 60 within the safety period 24.

The control unit 16 is provided so as to operate the supply unit 12 in the safety period 24 using a reduced energy with respect to the normal operating period 30. For example, the control unit 16 could operate the supply unit 12 in the safety period 24 using an energy that is reduced with respect to the normal operating period 30 by at least 50%. In the present case, the control unit 16 is provided so as to interrupt the energy supply of the supply unit 12 during the safety period 24.

A duration 32 of the safety period 24 corresponds to at least twice the duration 34 of an operating parameter change of the placement unit 18. The duration 34 of the operating parameter change of the placement unit 18 could be for example 4 milliseconds so that the duration of the safety period 24 corresponds to at least 8 milliseconds. In the present exemplary embodiment, the duration 32 of the safety period 24 corresponds to at least one, in the present case precisely one, half period duration 26 of the mains AC voltage, in other words at least 10 milliseconds at a mains frequency of 50 hertz. The duration 34 of the operating parameter change of the placement unit 18 in the present case is 5 milliseconds.

After terminating the safety period 24, a further normal operating period 66 follows in which the control unit 16 operates the supply unit 12 so that the energy that is provided inductively by the supply induction element 14 is adapted to the amended operating parameter of the operating parameter set of the placement unit 18, wherein an electrical power that is provided during the further normal operating period 66 corresponds to a power requirement of the placement unit 18 in the second operating mode.

FIG. 3 shows a schematic method flow diagram of a method for operating the induction energy transmission system 10. In the method, in the event of a signaled modification of at least one operating parameter of the operating parameter set of the placement unit 18 a safety period 24 is introduced within which the energy, which is provided inductively by the supply unit 12, is adapted to the modified operating parameter. The method comprises at least two method steps 62, 64. In a first method step 62 of the method, a planned modification of the operating parameter is signaled by the placement unit 18, namely via the communication unit 36. In a second method step 64 of the method, the safety period 24 is introduced and the energy, which is provided inductively by the supply unit 12, is adapted to the modified operating parameter.

### REFERENCE CHARACTERS

10 Induction energy transmission system
12 Supply unit
14 Supply induction element
16 Control unit
18 Placement unit
20 Further placement unit
22 Receiving induction element
24 Safety period
26 Period duration
28 Time period
30 Normal operating period
32 Duration of the safety period
34 Duration of an operating parameter change
36 Communication unit
38 Small household appliance
40 Further small household appliance
42 Cooktop
44 Placement plate
46 Half period duration
48 Communication element
50 Further communication element
52 Further communication element
54 Abscissa
56 Ordinate
58 First point in time
60 Second point in time
62 First method step
64 Second method step
66 Further normal operating period

1-12. (canceled)

13. An induction energy transmission system, comprising:
a supply unit including a supply induction element designed to inductively provide energy;
a placement unit including a receiving induction element designed to receive the inductively provided energy, said placement unit including an operating parameter set; and
a control unit designed to control the supply unit and in the event of a signaled modification of an operating parameter of the operating parameter set of the placement unit to introduce a safety period and to adapt the inductively provided energy to the modified operating parameter within the safety period.

14. The induction energy transmission system of claim 13, constructed in a form of an induction cooking system.

15. The induction energy transmission system of claim 13, wherein the placement unit is designed to signal a period duration of a mains AC voltage prior to a planned modification of the operating parameter of the operating parameter set.

16. The induction energy transmission system of claim 13, wherein the control unit is designed to transmit a time period of the safety period to the placement unit.

17. The induction energy transmission system of claim 13, wherein the control unit is designed to operate the supply unit in the safety period using a reduced energy with respect to a normal operating period.

18. The induction energy transmission system of claim 13, wherein the control unit is designed to interrupt an energy supply of the supply unit during the safety period.

19. The induction energy transmission system of claim 13, wherein a duration of the safety period corresponds to at least twice a duration of an operating parameter change of the placement unit.

20. The induction energy transmission system of claim 13, wherein a duration of the safety period corresponds to at least a half period duration of a mains AC voltage.

21. The induction energy transmission system of claim 13, further comprising a communication unit designed to wirelessly transmit data between the placement unit and the control unit.

22. The induction energy transmission system of claim 21, wherein the data is wirelessly transmitted by NFC (Near Field Communication).

23. The induction energy transmission system of claim 13, wherein the placement unit is designed as a small household appliance.

24. A small household appliance of an induction energy transmission system, said small household appliance comprising:
a receiving induction element designed to receive inductively provided energy from a supply unit; and
an operating parameter set including an operating parameter which in the event of a signaled modification causes introduction of a safety period and adaptation of the inductively provided energy to the modified operating parameter within the safety period.

25. A cooktop of an induction energy transmission system, comprising:
a supply unit including a supply induction element designed to inductively provide energy for transmission to a placement unit; and
a control unit designed to control the supply unit and in the event of a signaled modification of an operating parameter of an operating parameter set of the placement unit to introduce a safety period and to adapt the inductively provided energy to the modified operating parameter within the safety period.

26. The cooktop of claim 25, wherein the control unit is designed to transmit a time period of the safety period to the placement unit.

27. The cooktop of claim 25, wherein the control unit is designed to operate the supply unit in the safety period using a reduced energy with respect to a normal operating period.

28. The cooktop of claim 25, wherein the control unit is designed to interrupt an energy supply of the supply unit during the safety period.

29. A method for operating an induction energy transmission system, said method comprising:
inductively providing energy by a supply induction element of a supply unit of the induction energy transmission system;
transmitting the inductively provided energy to a receiving induction element of a placement unit of the induction energy transmission system;
introducing a safety period in the event of a signaled modification of an operating parameter of an operating parameter set of the placement unit; and
adapting within the safety period the inductively provided energy to the modified operating parameter.

30. The method of claim 29, further comprising transmitting a time period of the safety period to the placement unit.

31. The method of claim 29, further comprising operating the supply unit in the safety period using a reduced energy with respect to a normal operating period.

32. The method of claim 29, further comprising interrupting an energy supply of the supply unit during the safety period.
